(19) United States
(12) Patent Application Publication
(10) Pub. No.: US 2023/0317111 A1
(43) Pub. Date: Oct. 5, 2023

(54) NEAR-FIELD ACTIVE OPTICAL PROBE FOR HEAT-ASSISTED MAGNETIC RECORDING

(71) Applicants: ALEXANDER A. UKHANOV, ALBUQUERQUE, NM (US); GENNADY A. SMOLYAKOV, ALBUQUERQUE, NM (US); FEI HUNG CHU, FREMONT, CA (US)

(72) Inventors: ALEXANDER A. UKHANOV, ALBUQUERQUE, NM (US); GENNADY A. SMOLYAKOV, ALBUQUERQUE, NM (US); FEI HUNG CHU, FREMONT, CA (US)

(73) Assignee: ACTOPROBE LLC, ALBUQUERQUE, NM (US)

(21) Appl. No.: 18/206,251

(22) Filed: Jun. 6, 2023

(51) Int. Cl. G11B 13/08

(52) U.S. Cl. CPC G11B 13/08; G11B 2005/0021

(57) ABSTRACT

A diode-laser-based active transducer integrated on a heat-assisted magnetic recording head includes a diode laser structure, as a laser source, and a waveguide-transducer integrated with the laser structure as an intracavity element. Being a part of the laser cavity, the waveguide-transducer very efficiently delivers and couples the high-intensity intracavity laser light to a plasmonic antenna/transducer that concentrates the delivered near-field light to an optical spot of subwavelength nano-size volume to locally heat the surface of the magnetic recording medium.

### FIELD OF THE INVENTION

The present invention relates to magnetic data storage and retrieval systems, and more particularly relates to a heat-assisted magnetic recording (HAMR) system with a laser source integrated on a HAMR head.

### BACKGROUND OF THE INVENTION

### AFM Active Optical Probes

A novel class of probes for atomic force microscopy (AFM active optical probe—AAOP) monolithically integrating a diode laser source and an AFM probe has been recently described in [Rotter 2015], [Ukhanov 2016], [Chu 2018], [Ukhanov 2020], [Ukhanov 2021], [Ukhanov 2022a], [Ukhanov 2022b], [Chu 2022] to be used in a conventional AFM to enhance its functionality by including that of near-field scanning optical microscopy (NSOM) and tip-enhanced Raman spectroscopy (TERS). The AAOP is designed as an intracavity probe, that is, the AFM probe is part of the laser cavity as shown in an equivalent optical schematic of the device in FIG. 1. In this design, the high-intensity intracavity laser light is very efficiently delivered and coupled to the apex of the probe tip, generating a very strong optical field highly localized at the apex of the AFM tip. The AAOP, therefore, is a very efficient source of optical near field localized to subwavelength nano-size volume that takes advantage of the large intensity of the intracavity laser light coupled to the tip apex or transmitted through a subwavelength hole (tip aperture) for efficient excitation of the sample at the nanoscale.

In one instance, the laser cavity is defined by two distributed Bragg reflector (DBR) mirrors (FIG. 2). The first laser mirror is a standard first-order DBR grating (period λ/2n_{eff}, where λ is the laser wavelength and n_{eff} is the effective refractive index of the GaAs waveguide) that ensures single longitudinal mode for the laser operation. The second laser mirror is a second-order DBR grating (period k/n_{eff}). It serves as a folding mirror that couples the light (an intracavity laser mode) vertically into the AFM tip fabricated from a specially grown GaAs epitaxial overcap layer on top of the ridge waveguide. Thus, the light generated by the laser is coupled into the surface mode of the GaAs probe (conical shaped micro-prism) and transferred to the tip apex. The tip itself is a total internal reflection prism that plays the role of an output mirror, the third mirror, in the laser cavity. The GaAs micro-prism guides the laser light into the tip apex and generates a strong surface optical mode at the GaAs/air interface. It creates a high magnitude optical field highly localized at the apex of the AFM tip.

In another instance (FIG. 3), the laser is a second-order distributed feedback (DFB) surface-emitting laser that employs its second-order waveguide grating to outcouple the laser light vertically into the AFM tip fabricated from a specially grown GaAs epitaxial overcap layer on top of the ridge waveguide. Again, the light generated by the laser is coupled into the surface mode of the GaAs probe (conical shaped micro-prism) and transferred to the tip apex. Practice of the present invention can be easily extended to graded second-order DFB lasers for much more efficient power extraction to increase the optical power delivered to the GaAs probe. Graded second-order DFB lasers employ aperiodic gratings with symmetrically changing grating period to achieve a very significant enhancement of power extraction in vertical direction [Xu 2012]. In yet another instance, the mirrors of the laser cavity can be in the form of facets obtained by cleaving or etching the laser wafer or by applying Focused Ion Beam (FIB) in proper directions (FIG. 4). For example, one mirror can be fabricated by cleaving or etching the wafer perpendicular to the epitaxial layers and the other, folding mirror, can be fabricated using FIB applied in such a way as to create a flat surface at 45° with respect to the wafer surface. Again, the light generated by the laser is coupled by folding mirror into the GaAs probe (conical shaped micro-prism) and transferred to the tip apex where it creates a high magnitude optical field highly localized at the apex of the AFM tip.

### Heat-Assisted Magnetic Recording

A solution of a similar problem of delivering as much optical power as possible to as small spot as possible is being sought in heat-assisted magnetic recording (HAMR). In HAMR, electromagnetic radiation is used to locally heat the surface of the magnetic recording medium to facilitate the subsequent magnetic recording of information in the heated portion of the medium. HAMR utilizes an intense near-field optical source to elevate the temperature of the recording medium. To accomplish high areal density recording, it is essential to confine the light to the track where writing is taking place and to generate the write field in the close proximity to where the medium is heated. It is essential, therefore, to provide an efficient technique for delivering large amounts of light power to the recording medium confined to very small spots. Recording spot size of 50 nm in diameter is the current target in HAMR. The AAOP technology applied to HAMR is capable of significantly exceeding this spot size limit to achieve areal density recording of 10 Tb/in² and higher.

Like in TERS, near-field light generated by irradiating a plasmon antenna with a sharp-pointed part is typically used in HAMR to apply heat to the recording medium. In general, the laser light used for generating the near-field light is guided through a waveguide, provided in the slider of a magnetic disk drive, to the plasmonic antenna located near the recording medium facing surface of the slider. There are two possible ways for placement of the laser light source in the magnetic disk drive. The first way is to place the light source away from the slider. The second way is to fix it to the slider or even integrate it on the magnetic recording head. The first technique requires an extended optical path and multiple light redirecting optical structures and optical elements such as mirrors, lenses, and optical fibers to redirect the laser light and deliver it to the waveguide, which causes the problem of increasing energy loss of the light in the path. The second technique is free from that problem as it uses a much shorter optical path for guiding the light from the light source to the waveguide. Still, light coupling into the waveguide from an external laser light source causes very significant loss of light and generates undesirable heat in the HAMR head that may cause damage to the head due to repeated thermal cycling of the various materials in the optics, poles, and surrounding areas [Kryder 2008]. To overcome this problem, we take advantage of the technology developed for AAOP and propose a design for a HAMR head with an integrated diode-laser-based active transducer, where the waveguide is designed as an intracavity element, that is, the waveguide is part of the laser cavity. In this design, the high-intensity intracavity laser light is very efficiently delivered and coupled to the plasmonic antenna/transducer. The active transducer, therefore, is a very efficient source of optical near field localized to subwavelength nano-size volume that takes advantage of the large intensity of the intracavity laser light efficiently coupled to the plasmonic antenna/transducer.

### SUMMARY OF THE INVENTION

The invention provides a diode-laser-based active transducer integrated on a heat-assisted magnetic recording head that includes a diode laser structure, as a laser source, and a waveguide-transducer integrated with the laser structure as an intracavity element. Being a part of the laser cavity, the waveguide-transducer very efficiently delivers and couples the high-intensity intracavity laser light to a plasmonic antenna/transducer that concentrates the delivered near-field light to an optical spot of subwavelength nano-size volume to locally heat the surface of the magnetic recording medium.

### BRIEF DESCRIPTION OF THE DRAWINGS

FIG. 1 is a schematic illustration of the AAOP optical scheme.

FIGS. 2-4 are schematic views of the AAOP in various aspects.

FIG. 5 is a schematic view of a HAMR head integrated with a diode-laser-based active transducer in accordance with one aspect of the invention.

FIGS. 6-8 are schematic views of a diode-laser-based active transducer in accordance with various aspects of the invention.

FIGS. 9-12 are schematic views of a diode-laser-based active transducer coupled to a plasmonic antenna/transducer in accordance with various aspects of the invention.

FIGS. 13-14 are illustrations of a special epitaxial laser structure design with incorporated photonic band crystal (PBC) waveguide.

FIG. 15 is a schematic view of a HAMR head integrated with a diode-laser-based active transducer in accordance with various aspects of the invention.

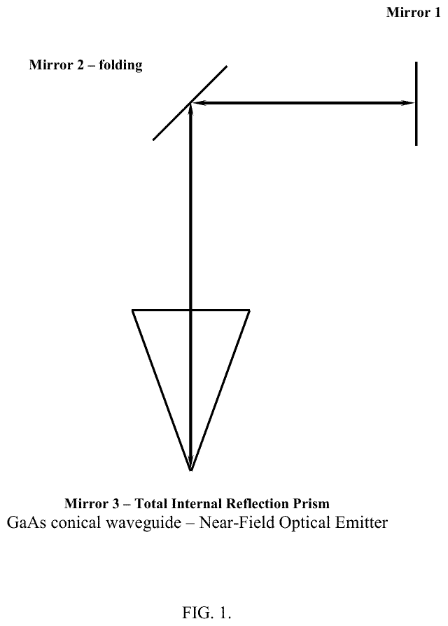

### DETAILED DESCRIPTION OF THE INVENTION

Some preferred embodiments of the invention will be described below in detail based on the drawings. In various aspects, the invention describes apparatus that can be used in heat assisted magnetic recording, as well as in data storage devices that include the apparatus. The invention provides a manufacturable and efficient device for coupling light from a laser diode and into the waveguide-transducer of a HAMR recording head.

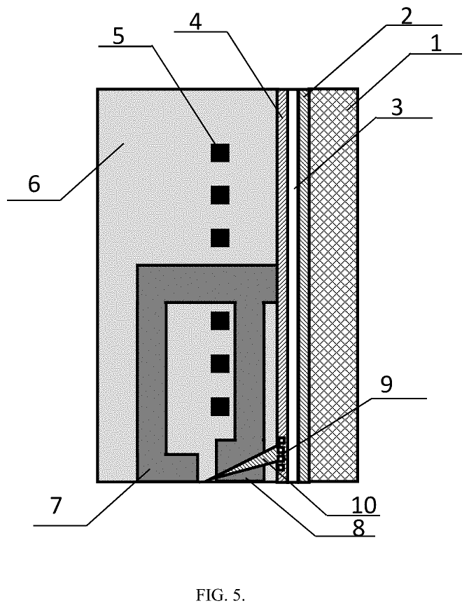

FIG. 5. is a pictorial representation of a fully integrated thin-film HAMR head. This head includes an integrated diode-laser-based active transducer, which includes, in this specific instance, a diode laser structure that consists of substrate 1, which can be, for example, GaAs, lower cladding layer 2, lasing active region 3, upper cladding layer 4, grating 9, and a waveguide-transducer (conical shaped prism) 10, as an integrated component, to deliver near field light concentrated to optical spot used to locally heat the surface of the magnetic recording medium. The head further includes write and return magnetic poles, labeled as 7 and 8, respectively. A slider 6 is designed to include the electronic parts such as the coil, writing and reading pole, etc. The magnetic core with a coil 5 is mounted in such a way that ends of the write and return poles are positioned adjacent to an air bearing surface of a slider. The magnetic coil 5 can be energized with a writing current to deliver the magnetic field in the write pole 7. The conical shaped waveguide-transducer 10 goes through an opening in the return magnetic pole 8 to reach the air bearing surface of the slider and to be at several nanometers distance from the magnetic recording medium.

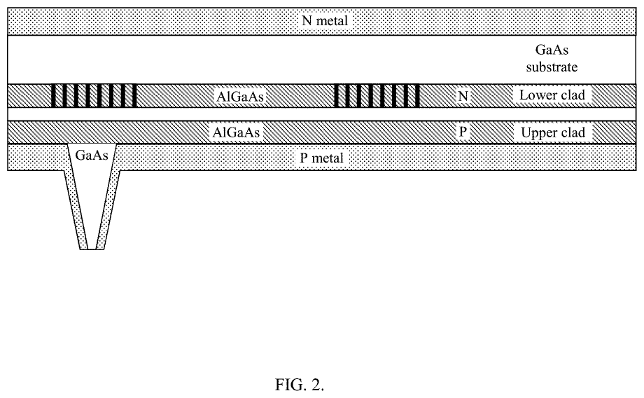

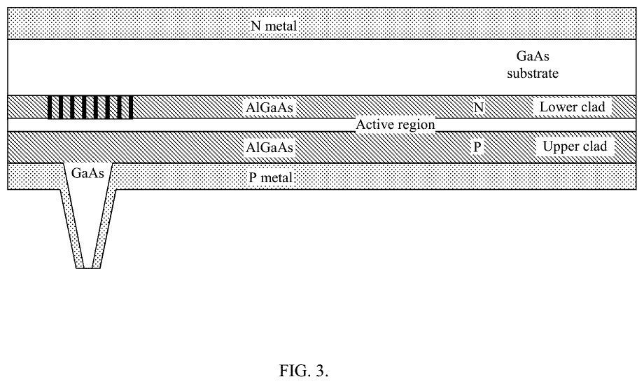

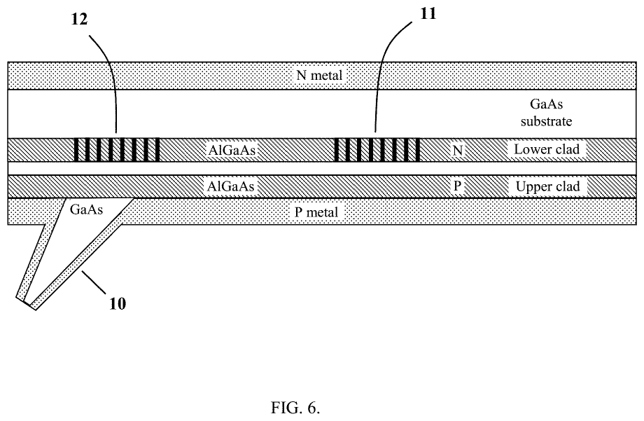

The integrated diode-laser-based active transducer can be designed in such a way as to couple the intracavity laser light vertically into the conical shaped waveguide-transducer, perpendicularly to the layers of the laser epitaxial structure. Three instances of such design are described in the “Background of the Invention” section and illustrated in FIGS. 2, 3, and 4. Alternatively, the integrated diode-laser-based active transducer can be designed in such a way as to couple the intracavity laser light into the conical shaped waveguide-transducer formed at a certain angle, significantly exceeding 90°, to the layers of the laser epitaxial structure. In one instance, the three-mirror laser cavity is defined by a distributed Bragg reflector (DBR) mirror, a grating coupler element, and the gold-coated conical shaped waveguide transducer that plays the role of an output mirror in the laser cavity (FIG. 6). The first laser mirror is a standard first-order DBR grating 11 (period λ/2n_{eff}, where λ is the laser wavelength and n_{eff} is the effective refractive index of the GaAs waveguide) that ensures single longitudinal mode for the laser operation. The second laser mirror is a grating coupler 12 that serves as a folding mirror that couples the intracavity laser light into the conical shaped gold-coated waveguide-transducer 10 formed at a certain angle, significantly exceeding 90°, to the layers of the laser epitaxial structure. The conical shaped waveguide-transducer is fabricated from a specially grown GaAs epitaxial overcap layer or a polymer layer deposited on top of the ridge waveguide. Thus, the light generated by the laser is coupled into the mode of the waveguide-transducer and transferred to its apex where it plasmonically excites a high-intensity optical near-field spot localized to subwavelength nano-size volume.

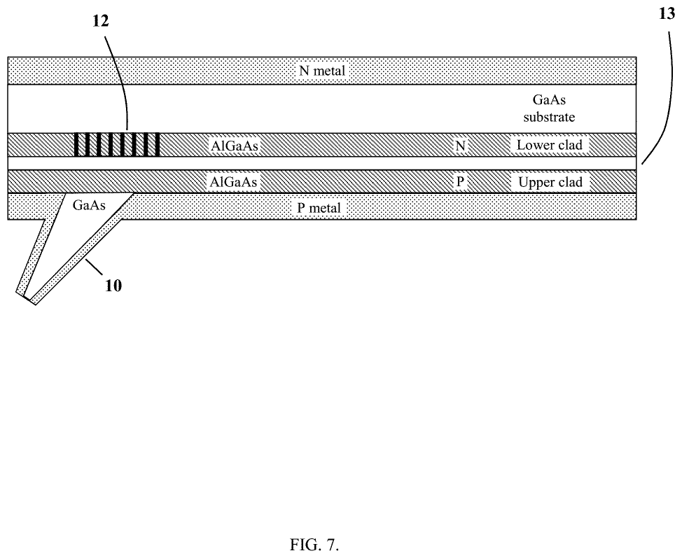

In another instance, the three-mirror laser cavity is defined by a mirror in the form of a facet obtained by cleaving or etching the laser wafer or by applying Focused Ion Beam (FIB) in proper directions, a grating coupler element, and the gold-coated conical shaped waveguide transducer that plays the role of an output mirror in the laser cavity (FIG. 7). The first laser mirror 13 can be fabricated by cleaving or etching the wafer perpendicular to the epitaxial layers. The second laser mirror is a grating coupler 12 that serves as a folding mirror that couples the intracavity laser light into the conical shaped gold-coated waveguide-transducer 10 formed at a certain angle, significantly exceeding 90°, to the layers of the laser epitaxial structure. The conical shaped waveguide-transducer is fabricated from a specially grown GaAs epitaxial overcap layer or a polymer layer deposited on top of the ridge waveguide. Thus, the light generated by the laser is coupled into the mode of the waveguide-transducer and transferred to its apex where it plasmonically excites a high-intensity optical near-field spot localized to subwavelength nano-size volume.

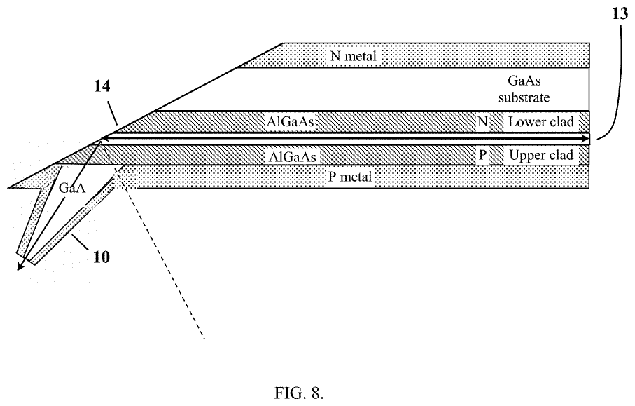

In yet another instance, the first and second mirrors of the laser cavity can be in the form of facets obtained by cleaving or etching the laser wafer or by applying Focused Ion Beam (FIB) in proper directions (FIG. 8). For example, the first mirror 13 can be fabricated by cleaving or etching the wafer perpendicular to the epitaxial layers and the second, folding mirror 14, can be fabricated using FIB applied in such a way as to create a flat surface at a certain angle, smaller than 45°, with respect to the wafer surface. Again, the second folding laser mirror couples the intracavity laser light into the conical shaped gold-coated waveguide-transducer 10 formed at a certain angle, significantly exceeding 90°, to the layers of the laser epitaxial structure. The conical shaped waveguide-transducer is fabricated from a specially grown GaAs epitaxial overcap layer or a polymer layer deposited on top of the ridge waveguide. Thus, the light generated by the laser is coupled into the mode of the waveguide-transducer and transferred to its apex where it plasmonically excites a high-intensity optical near-field spot localized to subwavelength nano-size volume.

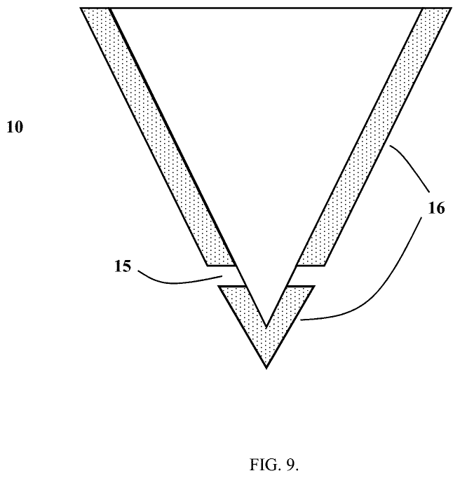

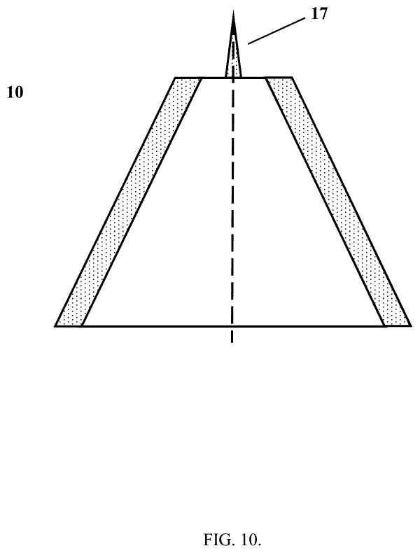

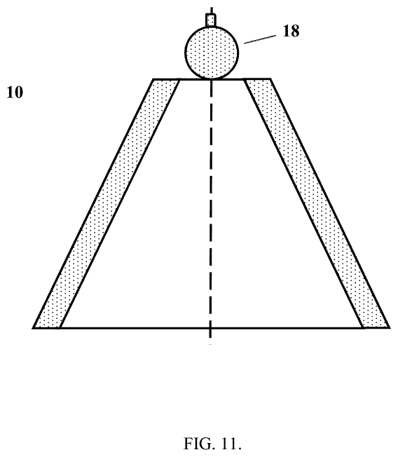

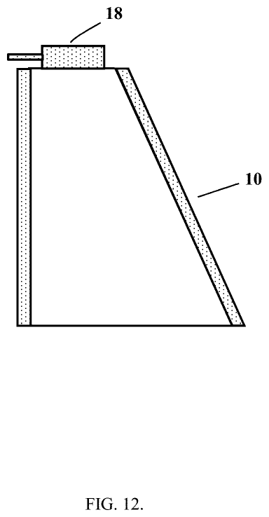

The gold-coated conical shaped waveguide-transducer 10 can be used in combination with additional metallic near-field transducers (NFTs) acting as plasmonic antennas for generating a high-intensity optical near-field spot localized to subwavelength nano-size volume. Illustrated in FIG. 9 is a version of the waveguide-transducer 10 where the gap 15 in the gold coating 16 lets the light focused to ˜λ/2n spot to leave the waveguide and to plasmonically excite the remaining part of the gold coating at the apex of the conical shaped waveguide to create a high-intensity optical near-field spot localized to subwavelength nano-size volume. The conical shaped waveguide 10 can be truncated in such a way as to employ the light focused to ˜λ/2n spot for further plasmonic excitation of a needle-like NFT 17, as shown in FIG. 10. Similar scheme can be used for plasmonic excitation in a lollipop NFT 18, as shown in FIG. 11. When it is necessary, the geometry of the waveguide 10 and lollipop NFT 18 can be adjusted as shown in FIG. 12 to deliver the laser light, localized into the high-intensity optical near-field spot, to the recording medium. It may be required in a situation when the intracavity laser light is vertically coupled into the conical shaped waveguide-transducer, that is perpendicularly to the layers of the laser epitaxial structure.

In all instances, we envisage employing a specially designed semiconductor laser epitaxial structure with significantly improved vertical divergence of the laser emission. Strong vertical divergence of laser emission in a typical diode laser may prevent the proper operation of the active optical transducer device. Strong divergence of laser beam may happen before it enters the waveguide-transducer. As a result, the waveguide-transducer collects very little laser light insufficient for self-sustained laser operation. The special design of the laser epitaxial structure is intended to radically improve the laser light coupling into the waveguide-transducer and make self-sustained laser generation possible in the intracavity design of the active optical transducer. Many ways have been proposed for improving divergence in semiconductor laser along the fast axis (across the epitaxial layers). Several designs have been introduced to reduce the transverse divergence such as the asymmetric waveguide [Bogatov 2008], [Zhang 2012], the super large optical cavity (SLOC) [Pietrzak 2011], [Pietrzak 2012], the graded index double barrier separate confinement heterostructure [Hung 2013], the passive far-field reduction layer [Hou 2012], the slab-coupled optical waveguide [Huang 2003], the plasmonic collimators [Blanchard 2013], and the longitudinal photonic band crystal (PBC) waveguide [Ledentsov 2002], [Maximov 2008], [Liu 2014], [Miah 2014], [Ma 2016]. Among them, only SLOC and longitudinal PBC designs demonstrate continuous wave (CW) power over 1 W and vertical divergence angle less than 10 degrees at full width at half maximum (FWHM). The PBC design was identified as the most promising one. An example of such design is given in [Liu 2014].

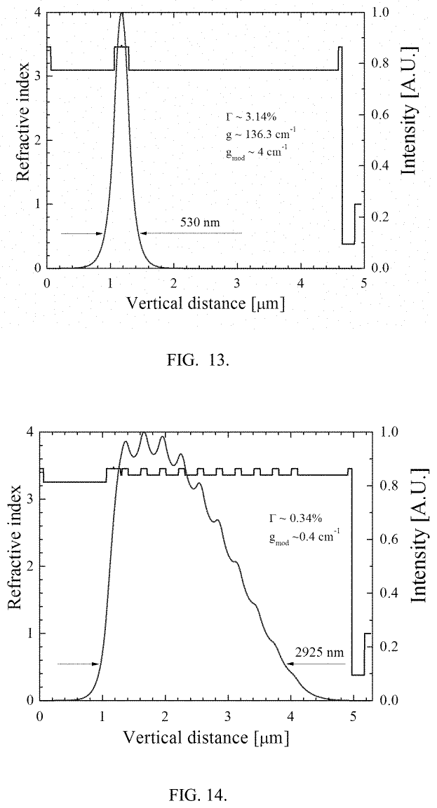

A special epitaxial laser structure with the incorporated PBC waveguide and 5 layers of InAs quantum dots (QDs) in the active region was designed for reduced vertical divergence. FIG. 13 shows the calculated fundamental transverse mode of a standard quantum dots (QDs) in a Well (QDWELL) epitaxial laser structure designed for lasing at 1250 nm. The mode size of ˜530 nm is shown at the 1/e² intensity level. The epitaxial structure is modified by introducing multiple coupled waveguides into the upper cladding. An example of the design with 10 coupled waveguide layers is shown below in FIG. 14. The obvious improvement in the fundamental transverse mode size comes at a price of ˜10 times reduced modal gain. The epitaxial structure with a single QD-in-a-Well layer may not provide enough material gain to reach threshold even at high injection currents as the gain in QD is known to saturate. Epitaxial structures with multiple layers of QDs in QWs are the best solution, and an asymmetric 5-QDWELL epitaxial laser structure with a PBC waveguide consisting of 10 coupled waveguides introduced into upper cladding layer has been designed for reduced vertical divergence.

To fabricate the example structure in FIG. 5, the substrate can be either semiconductor (e.g. gallium arsenide) or standard recording head material (e.g. AlTiC). If semiconductor substrate is used, the epitaxial layer that forms the active region of the laser can be grown directly on the substrate. If standard recording head material is used as substrate, a semiconductor seed layer can be grown first followed by the growth of the epitaxial layer. The optical waveguide can be formed using etching or ion implantation. Following the formation of waveguides, a second-order grating can be fabricated at one end of the waveguide where the conical shaped waveguide-transducer will be located.

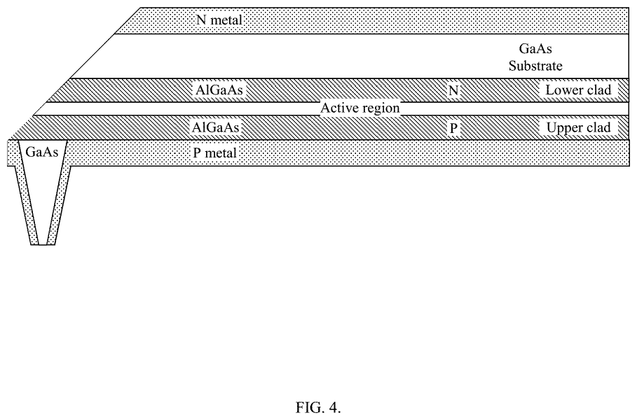

The second-order grating is only one of the many examples to direct the laser beam toward the waveguide-transducer. Another example is by polishing the end facet (FIG. 4 and FIG. 8) with an angle depending on the design, so that the facet becomes a folding mirror.

The conical shaped waveguide-transducer can be fabricated from either polymer or semiconductor. For semiconductor waveguide-transducers, an extra layer of semiconductor with a thickness equal to the height of the conical shaped waveguide will be added during the epitaxial growth. The conical shaped waveguides can then be fabricated using lithography followed by anisotropic wet etching. For polymer conical shaped waveguides, the polymer material will be spin-coated with a thickness equal to the height of the conical shaped waveguide. A metal or dielectric etch mask will be deposited with a pattern defined by lithography followed by angled dry etching.

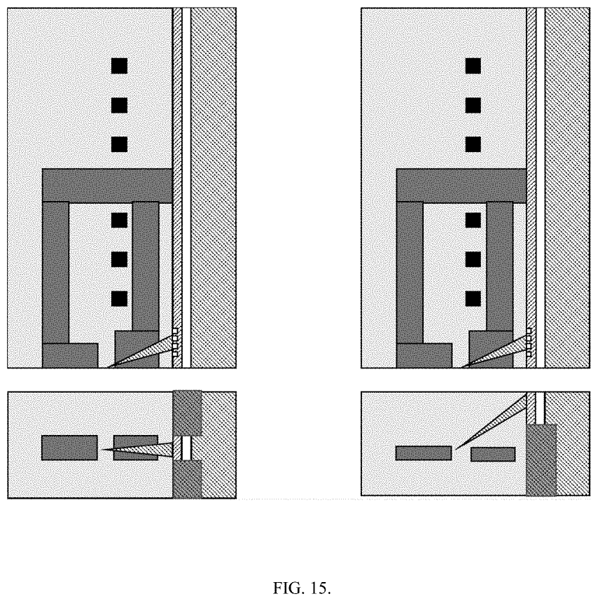

There are several ways of placing and orienting the conical shaped waveguides (FIG. 15). In one example, the laser active region and the conical shaped waveguide can be located right underneath the magnetic poles, with the conical shaped waveguide surrounded by the material of magnetic return pole and the apex of the conical shaped waveguide right at the center of the gap between the two poles (FIG. 15, left). In another example, the laser active region and the conical shaped waveguide can be fabricated on the side of the poles, with the conical shaped waveguide pointing toward the center of the gap between the two poles without penetrating the magnetic return pole, and thus minimizing its effect on the magnetic field (FIG. 15, right).

After the conical shaped waveguide-transducer is fabricated, the rest of the recording head can be fabricated on top of the laser structure. A typical process is as follows:
1. Deposition of a layer of metal (e.g. alumina);
2. Deposition and patterning (or electroplating, sputtering, etc.) of bottom magnetic poles (e.g. NiFe, amorphous Co-based alloy, etc.);
3. Deposition and patterning (e.g. by sputtering) of a gap layer (e.g. alumina);
4. Deposition and patterning (deposition method depends on the material used) of a layer of insulator (e.g. photoresist), followed by curing if necessary;
5. Deposition (e.g. by electroplating) and patterning of spiral coils (copper or other material). If electroplating is used, a seed layer needs to be deposited first;
6. Deposition and patterning (deposition method depends on the material used) of another layer of insulator (e.g. photoresist), followed by curing if necessary;
7. Deposition and patterning (or electroplating, sputtering, etc.) of top magnetic poles (e.g. NiFe, amorphous Co-based alloy, etc).

Although certain embodiments of the invention have been described in detail herein, those skilled in the art will appreciate that modifications and changes can be made therein with the scope of the invention as set forth in the appended claims.

### REFERENCES CITED

[Blanchard 2013] R. Blanchard, T. S. Mansuripur, B. Gokden, N. F. Yu, M. Kats, P. Genevet, K. Fujita, T. Edamura, M. Yamanishi, and F. Capasso, “High-power low-divergence tapered quantum cascade lasers with plasmonic collimators”, Appl. Phys. Lett. 102(#19), Art. 191114, May 2013.
[Bogatov 2008] A. P. Bogatov, T. I. Gushchik, A. E. Drakin, A. P. Nekrasov, V. V. Popovichev, “Optimisation of waveguide parameters of laser InGaAs/AlGaAs/GaAs heterostructures for obtaining the maximum beam width in the resonator and the maximum output power”, Quantum Electron. 38(#10), pp. 935-939, October 2008.
[Chu 2018] F. H. Chu, G. A. Smolyakov, C. F. Wang, Y. Gao, C. Wang, K. J. Malloy, A. A. Ukhanov, D. V. Pete, M. Jaime-Vasquez, N. F. Baril, J. D. Benson, D. A. Tenne, “Tip-enhanced stimulated Raman scattering with ultra-high-aspect-ratio tips and confocal polarization Raman spectroscopy for evaluation of sidewalls in Type II superlattices FPAs”, Proc. SPIE 10726, Nanoimaging and Nanospectroscopy VI, 107261C, 2018.
[Chu 2022] F.-H. Chu, G. A. Smolyakov, K. J. Malloy, A. A. Ukhanov, “Novel semiconductor-laser-integrated active AFM optical probe with ultrashort pulses and nanoscale aperture”, Proc. SPIE 11967, Single Molecule Spectroscopy and Superresolution Imaging XV, 1196707, 2022.
[Hou 2012] L. P. Hou, M. Haji, J. Akbar, A. C. Bryce, and J. H. Marsh, “160-GHz 1.55-μm colliding-pulse mode-locked AlGaInAs/InP laser with high power and low divergence angle”, IEEE Photon. Technol. Lett. 24(#12), pp. 1057-1059, June 2012.
[Huang 2003] R. K. Huang, J. P. Donnelly, L. J. Missaggia, C. T. Harris, J. Plant, D. E. Mull, and W. D. Goodhue, “High-power nearly diffraction-limited AlGaAs—InGaAs semiconductor slab-coupled optical waveguide laser”, IEEE Photon. Technol. Lett. 15(#7), pp. 900-902, July 2003.
[Hung 2013] C. T. Hung and T. C. Lu, “830-nm AlGaAs—InGaAs graded index double barrier separate confinement heterostructures laser diodes with improved temperature and divergence characteristics”, IEEE J. Quantum Electron. 49(#1), pp. 127-132, January 2013.
[Kryder 2008] M. H. Kryder, E. C. Gage, T. W. Mcdaniel, W. A. Challener, R. E. Rottmayer, G. P. Ju, Y. T. Hsia, M. F. Erden, “Heat assisted magnetic recording”, Proc. IEEE 96(#11), pp. 1810-1835, November 2008.
[Ledentsov 2002] N. N. Ledentsov and V. A. Shchukin, “Novel concepts for injection lasers”, Opt. Eng. 41(#12), pp. 3193-3203, December 2002.
[Liu 2014] L. Liu, H. Qu, Y. Liu, Y. Zhang, Y. Wang, A. Qi, W. Zheng, “High-power narrow-vertical-divergence photonic band crystal laser diodes with optimized epitaxial structure”, Appl. Phys. Lett. 105(#23), Art. 231110, December 2014.
[Ma 2016] X. L. Ma, A. J. Liu, H. W. Qu, Y. Liu, P. C. Zhao, X. J. Guo, W. H. Zheng, “Nearly diffraction-limited and low-divergence tapered lasers with photonic crystal structure”, IEEE Photon. Technol. Lett. 28(#21), pp. 2403-2406, November 2016.
[Maximov 2008] M. V. Maximov, Y. M. Shernyakov, I. I. Novikov, L. Y. Karachinsky, N. Yu. Gordeev, U. Ben-Ami, D. Bortman-Arbiv, A. Sharon, V. A. Shchukin, N. N. Ledentsov, T. Kettler, K. Posilovic, D. Bimberg, “High-power low-beam divergence edge-emitting semiconductor lasers with 1- and 2-D photonic bandgap crystal waveguide”, IEEE J. Sel. Topics Quantum Electorn. 14(#4), pp. 1113-1122, July-August 2008.
[Miah 2014] M. J. Miah, T. Kettler, K. Posilovic, V. P. Kalosha, D. Skoczowsky, R. Rosales, D. Bimberg, J. Pohl, M. Weyers, “1.9 W continuous-wave single transverse mode emission from 1060 nm edge-emitting lasers with vertically extended lasing area”, Appl. Phys. Lett. 105(#15), Art. 151105, October 2014.
[Pietrzak 2011] A. Pietrzak, P. Crump, H. Wenzel, G. Erbert, F. Bugge, and G. Trankle, “Combination of low-index quantum barrier and super large optical cavity designs for ultranarrow vertical far-fields from high-power broad-area lasers”, IEEE J. Sel. Top. Quantum Electron. 17(#6), pp. 1715-1722, November-December 2011.
[Rotter 2015] T. J. Rotter, T. Busani, P. Rathi, F. Jaeckel, P. A. Reyes, K. J. Malloy, A. A. Ukhanov, E. Plis, S. Krishna, M. Jaime-Vasquez, N. F. Baril, J. D. Benson, and D. A. Tenne “Confocal Raman spectroscopy and AFM for evaluation of sidewalls in type II superlattice FPAs”, Proc. SPIE 9451, Infrared Technology and Applications XLI, 94510R, 2015.
[Ukhanov 2016] A. A. Ukhanov, G. A. Smolyakov, “Atomic force microscopy active optical probe”, U.S. Pat. No. 9,482,691, issued Nov. 1, 2016.
[Ukhanov 2020] A. A. Ukhanov, G. A. Smolyakov, “VCSEL-based resonant-cavity-enhanced atomic force microscopy active optical probe”, U.S. Pat. No. 10,663,485, issued May 26, 2020.
[Ukhanov 2021] A. A. Ukhanov, G. A. Smolyakov, F. H. Chu, C. Wang, “Monolithic atomic force microscopy active optical probe”, U.S. Pat. No. 11,016,119, issued May 25, 2021.
[Ukhanov 2022a] A. A. Ukhanov, G. A. Smolyakov, F. H. Chu, B. Kafle, “Semiconductor-laser-integrated atomic force microscopy optical probe”, U.S. patent application Ser. No. 17/697,314, submitted Mar. 17, 2022.
[Ukhanov 2022b] Ukhanov, Alexander, Smolyakov, Gennady, Chu, Fei-Hung, Tenne, Dmitri, Rack, Jeffrey, and Malloy, Kevin. Atomic Force Microscope Active Optical Probe for Single-Molecule Imaging and Time-Resolved Optical Spectroscopy (DOE SBIR Phase II/IIA Final Report). United States: N. p., 2022. Web. doi:10.2172/1887584.
[Xu 2012] G. Y. Xu, R. Colombelli, S. P. Khanna, A. Belarouci, X. Letartre, L. H. Li, E. H. Linfield, A. G. Davies, H. E. Beere, D. A. Ritchie, “Efficient power extraction in surface-emitting semiconductor lasers using graded photonic heterostructures”, Nature Communications 3, Article Number 952, 2012.
[Zhang 2012] J. X. Zhang, L. Liu, W. Chen, A. J. Liu, W. J. Zhou, and W. H. Zheng, “Large spot size and low-divergence angle operation of 917-nm edge-emitting semiconductor laser with an asymmetric waveguide structure”, Chin. Opt. Lett. 10(#6), Art. 061401, June 2012.

We claim:

1. A thin-film recording head for heat-assisted magnetic recording comprising a magnetic write pole having an end positioned adjacent to an air bearing surface and a diode-laser-based active transducer,
the diode-laser-based active transducer comprising:
a semiconductor laser source; and
a waveguide-transducer that receives light from the semiconductor laser source and delivers it to an optical spot used to locally heat surface of a magnetic recording medium, all monolithically integrated into the thin-film magnetic recording head on a common substrate.

2. The recording head of claim 1, wherein the semiconductor laser source is based on an epitaxial laser structure, layers of which are integrated into the thin-film magnetic recording head.

3. The recording head of claim 2, wherein the waveguide-transducer is fabricated from a thick overcap layer of the epitaxial laser structure or from a polymer layer deposited on top of the epitaxial laser structure.

4. The recording head of claim 3, wherein the waveguide-transducer has conical shape and is coated with gold.

5. The recording head of claim 4, wherein the waveguide-transducer is designed as an intracavity element, that is, the waveguide-transducer is part of a laser cavity that delivers high-intensity intracavity laser light to an optical spot used to locally heat surface of a magnetic recording medium.

6. The recording head of claim 5, wherein the semiconductor laser source is defined by fabricating two mirrors, mirror #1 and mirror #2, out of the epi-layers of the epitaxial laser structure.

7. The recording head of claim 6, wherein mirror #1 and mirror #2 of the laser cavity are in the form of facets or edges obtained by etching or cleaving the laser wafer, or by applying focused ion beam in proper directions:
mirror #1 is fabricated by etching or cleaving the wafer perpendicular to the epitaxial layers;
mirror #2, the folding mirror, is fabricated in such a way as to create a flat surface at 45° with respect to the wafer surface and is used to couple the intracavity laser light vertically into the conical shaped waveguide-transducer, perpendicularly to the layers of the laser epitaxial structure.

8. The recording head of claim 6, wherein mirror #1 and mirror #2 of the laser cavity are in the form of facets or edges obtained by etching or cleaving the laser wafer, or by applying focused ion beam in proper directions:
mirror #1 is fabricated by etching or cleaving the wafer perpendicular to the epitaxial layers;
mirror #2, the folding mirror, is fabricated in such a way as to create a flat surface at a certain angle, smaller than 45°, with respect to the wafer surface and is used to couple the intracavity laser light into the conical shaped waveguide-transducer formed at a certain angle, significantly exceeding 90°, to the layers of the laser epitaxial structure.

9. The recording head of claim 6, wherein mirror #1 is a standard first-order distributed Bragg reflector grating and mirror #2 is a second-order distributed Bragg reflector grating that serves as a folding mirror to couple the intracavity laser light vertically into the conical shaped waveguide-transducer, perpendicularly to the layers of the laser epitaxial structure.

10. The recording head of claim 6, wherein mirror #1 is a standard first-order distributed Bragg reflector grating and mirror #2 is a second-order distributed Bragg reflector grating that serves as a folding mirror to couple the intracavity laser light vertically into the conical shaped waveguide-transducer formed at a certain angle, significantly exceeding 90°, to the layers of the laser epitaxial structure.

11. The recording head of claim 5, wherein the semiconductor laser source is a second-order distributed-feedback surface-emitting laser that employs its second-order waveguide grating to outcouple the intracavity laser light vertically into the conical shaped waveguide-transducer, perpendicularly to the layers of the laser epitaxial structure.

12. The recording head of claim 6, wherein mirror #1 is in the form of a facet or an edge fabricated by etching or cleaving the wafer perpendicular to the epitaxial layers and mirror #2 is a grating coupler that serves as a folding mirror that couples the intracavity laser light into the conical shaped waveguide-transducer formed at a certain angle, significantly exceeding 90°, to the layers of the laser epitaxial structure.

13. The recording head of claim 1, wherein the semiconductor laser source is based on III-V semiconductor materials such as InP, GaP, GaSb, and GaN.

14. The recording head of claim 5, wherein the gold-coated conical shaped waveguide-transducer can be used in combination with additional metallic near-field transducers acting as plasmonic antennas for generating a high-intensity optical near-field spot localized to subwavelength nano-size volume.

15. The recording head of claim 5, wherein a specially designed semiconductor laser epitaxial structure with significantly improved vertical divergence of the laser emission is employed to radically improve the intracavity laser light coupling into the waveguide-transducer and make self-sustained laser generation possible in the intracavity design of the active optical transducer.
